(19) United States
(12) Patent Application Publication
(10) Pub. No.: US 2004/0025030 A1
(43) Pub. Date: Feb. 5, 2004

(54) Method and system for collection and verification of data from plural sites

(76) Inventors: Timothy Alexander Corbett-Clark, Suffolk (GB); Mark Rowan Gorton Holt, Cambridgeshire (GB)

Correspondence Address: NIXON & VANDERHYE, PC, 1100 N GLEBE ROAD, 8TH FLOOR, ARLINGTON, VA, 22201-4714, US

(21) Appl. No.: 10/296,260

(22) PCT Filed: May 21, 2001
(86) PCT No.: PCT/GB01/02252

(30) Foreign Application Priority Data
May 25, 2000 (GB) 00128405

(51) Int. Cl. H04L 9/00

(52) U.S. Cl. 713/186

(57) ABSTRACT

A system for providing secure and accurate acquisition of data, such as clinical trials data, from a plurality of sites comprises a plurality of mobile user stations and a plurality of validator stations which intercommunicate. The user stations include a mobile computer, communication links, interface to local medical devices to provide for capture of medical data and bar code printers for recording physical items and provide for user to fill an electronic case record form (CRF). When complete the form is digitally signed by a signature derived from a biometric authentication of the user and is submitted for immediate validation by the validator. The validator can either validate and sing off the form using a biometrically driven digital signature or can request correction of certain part of the form. Both the final form and any earlier version of it are stored in a secured database. The electronic case record forms are encoded in XML, with any arbitrary binary data encoded in Radix64. For digital signing of the forms the XML documents are normalized by removing contentless white spaces and converting text to Unicode before application of the digital signature algorithm. The digital signature and public key are encoded as Radix64 and appended to the XML document for transmission.

This invention relates to a system and method for the collection of data from plural sites into a single database, and in particular a system which has a high level of security providing for verification, authenticity and non-repudiation of the data, together with the production of a complete audit trail.

There are many fields and applications in which data, of varying types, is generated at a plurality of distributed sites. The collection of that data in a secure manner, such that the origin of the data is established, an audit trail for the data collection is produced, and the provision of some way of checking that the data submitted is useful presents a considerably technical challenge.

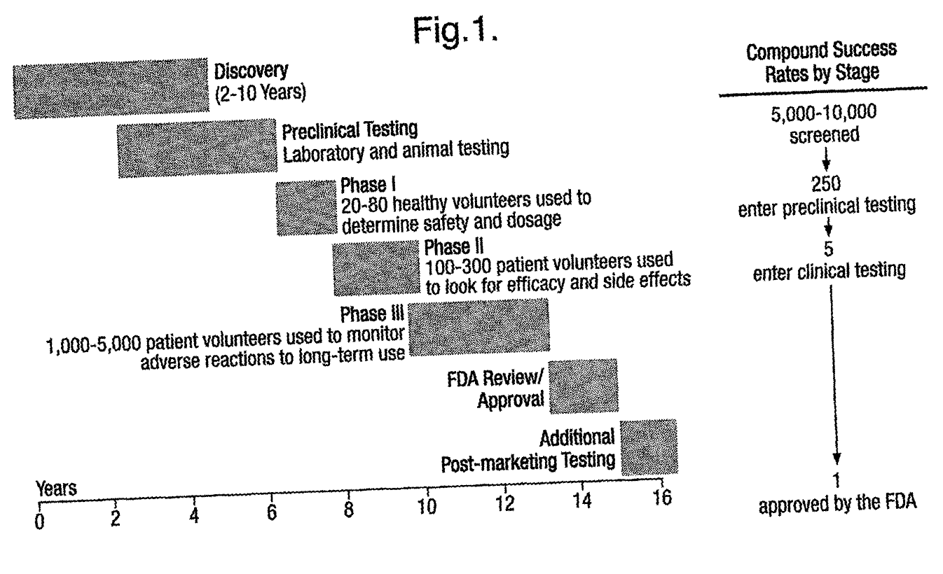

For instance, in the development of new drugs lengthy and expensive clinical trials are required in order to establish the safety and efficacy of the drugs. FIG. 1 of the accompanying drawings illustrates the process from discovery to approval and post-marketing testing, and also indicates the success rate at each stage. It can be seen that the initial phases, up to Phase II, involve relatively small numbers of patients and can therefore be conducted on a small number of sites. Phase III involves a large number of patient volunteers and almost inevitably is a multi-site process. Further, the tests are usually conducted over a period of three to six months or even longer. In all phases this process usually involves the patient volunteers being required to attend a clinic where physiological measurements are taken (ECG, blood pressure, heart rate, temperature, weight etc) and subjective comments recorded. This information is entered onto a case record form (CRF), which is retained. At the end of the trial all of the CRFs are collated and entered into database. This database is then submitted to the regulatory authorities for approval.

However, this system has a number of problems. The generation, handling and processing of large numbers of paper documents is time-consuming and expensive and prone to error. The transcription of those documents into a computer database also tends to introduce error. Further, any errors or omissions on the CRFs are only detected long after any remedial action is possible. This means that up to 15% of the data collected may be unuseable for various reasons. Also, there is no control over the quality or accuracy of the data which is entered.

The use of electronic data acquisition has been proposed in this field, as in others. However, the proposals have required users to be familiar with accessing the Internet in order to transfer data, and also it has been difficult to integrate the electronic acquisition of data with data obtained from medical devices and with records kept on existing paper forms and data in the form of samples from the patient.

The electronic transfer of data from remote sites also presents security problems. In many fields it is necessary to be sure that the data has been prepared and submitted by an authorized person, and that the data has not then been altered. The use of digital signatures and the public key/private key infrastructure does offer some solution to these problems, but this solution is difficult to apply when data is prepared in various sites and may, therefore, be encoded in different ways, e.g. using different character sets. Further, when data is transferred across system using different character sets, the validity of the digital signature may break down.

According to a first aspect the present invention provides a-system for the acquisition and verification of data from plural remote sites, the system comprising a plurality of user stations, a plurality of validator stations and a database for storing the data,

each of the user stations comprising a computer adapted to accept input of data to form a data set; a biometric identity verification device for verifying the identity of the user; means for digitally signing the data set and appending it to the data set to produce a signed data set; and communication means for transmitting the signed data set to one of the validator stations in response to biometric verification of the identity of the user and for receiving validation information from the validator stations;

each of the validator stations comprising a computer; a biometric identity verification device for verifying the identity of the validator; communication means for receiving the signed data set from the user stations and transmitting validation information to the user stations; means for appending a digital signature of the validator to the signed data set to produce a validated data set;

the database storing the signed data set and the validated data set.

The invention also provides a corresponding method of acquisition and verification of data, and user and validator stations for use in the system.

This system, therefore, has a number of advantages. The use of the biometric identity verification devices gives a good degree of security ensuring that the users and validators are authorized people. The use of the digital signature on the data sets means that the data sets cannot be changed after submission, and also that the identity of the user submitting the data set can be established. The validator stations provide for fast validation of the data set, thus reducing the occurrence of data being submitted to the system which is unuseable. The validator can check the data being submitted, and respond with either a validation of the data, or by making suggestions for correction of the data set. Finally, the fact that the database stores both the signed data set and the valid data set means that a complete audit trail is established. In other words, even though the data set may change following comments from the validator and an improved data collection procedure, the original data set is still present.

The validator stations are preferably mobile and compact, the computer being a portable computer (laptop). The user stations may also be mobile and compact, also using a portable computer. Preferably the hardware is all provided mounted for use in a small suitcase, optionally with a separate “support” bag carrying extensible power and telephone leads.

The data set may comprise user generated notes such as text or audio data as well as electronically-captured data, for instance measurements from a sensing device, which can be a medical device such as a blood pressure monitor, ECG, thermometer or oxygen saturation sensor. The user station preferably comprises an interface for interfacing to such a device, and conveniently the portable computer can display a user-manipulable representation of the controls of the device, such that the device can be controlled by manipulating the display, for instance using a computer mouse. This means that the user's existing experience in using the medical device is simply transferred to the use of the system.

To provide further security the use rights of the user station and validator station require verification of the identity of the user or validator by the biometric identity verification device and that use right will expire after a predetermined period of non-use of the system. Further, the digital signature may be obtained by reference to the output of the biometric identity verification device, for instance by using the biometric signal from the device to access a lookup table for the signatures.

To further improve the audit trail the database may store a time stamp recording the time of preparation and submission of the signed data set and validated data set.

To provide for the system to integrate closely with existing systems based on paper and samples, the user station may also comprise a bar code printer for printing bar codes on labels for application to such physical items. The bar code for the item is then stored in the data set and in the database, together with the identity of the physical item. Preferably the system further includes a bar code scanner for scanning such bar codes, or bar codes provided from elsewhere.

In order to improve the usability of the system the communication means may be adapted to make the communications effectively “invisible” to the user. Thus the user station can be adapted to establish communication links with the validator automatically, and automatically to recover communications in the event of a loss of the communication link, both without intervention of the user. Therefore even if during collection of data the communications link is lost, the user station can be programed automatically to try again later. To this end the communication link preferably comprises a cellular radio telephone wired or wireless LAN, or other types of link.

The system may further include monitoring stations which have read-only access to the database to allow sponsors of the data collection process to monitor the process. Such monitoring stations could run on general-purpose computers using a generic web-browser to display HTML or the like.

It will be appreciated that the system is particularly well adapted to the field of collecting clinical trials data, during any of the phases of the clinical trials process mentioned above. In this case the data might consist of patient records, text or audio notes on the response of the subjects to the drug, user obtained measurement data relating to the physical condition of the subject, electronically captured data from medical devices and video data recording examination of the subject.

Another aspect of the invention relates to security of data transfer. It provides a method of digitally signing a data set comprising the steps of converting the data set into a normalized representation, and applying a digital signing algorithm to a first key and to the normalized representation of the data set to produce the digital signature.

The use of the normalized representation is advantageous in always providing for the verification of the signature and signed data set. Thus even if during transmission or storage of the signed data set, the data is encoded differently (for instance because of local use of a different character set), the digital signature is always checked by converting the data into a normalized representation, before applying the digital signing or verification algorithm.

The data set may comprise text characters, in which case the normalized presentation is an international standard character set encoding the text characters as binary data, such as Unicode. The data set may be written in XML (Extended Mark-Up Language) and arbitrary binary data can be included in such a data set by encoding it as Radix64 characters. Similarly the digital signature and public key can also be encoded as Radix64 characters, with the public key and digital signature being appended to the data set, the whole then forming an XML document for transmission or storage.

It will be appreciated that the second aspect of the invention mentioned above can advantageously be combined with the first aspect to provide for good data security in the data collection system.

A third aspect of the invention provides a method of digitally signing a data set comprising the steps of obtaining a biometric signal from a user, obtaining a private key with reference to the biometric signal and applying a digital signing algorithm to the private key and to the data set to produce the digital signature.

The biometric signal can be obtained in a variety of ways, for instance by use of a fingerprint scan or iris scan.

The second and third aspects of the invention also provide corresponding apparatuses for digitally signing a data set in accordance with the methods.

The methods in the different aspects of the invention may involve, or be provided by, a computer program comprising program code means for executing the method. Thus the invention extends to such a computer program, a storage or transmission medium carrying the computer program, and general purpose computers programmed with the program.

The invention will be further described by way of non-limitative example with reference to the accompanying drawings in which:—

FIG. 1 schematically illustrates the timetable of a clinical trials process which is one possible application of the invention;

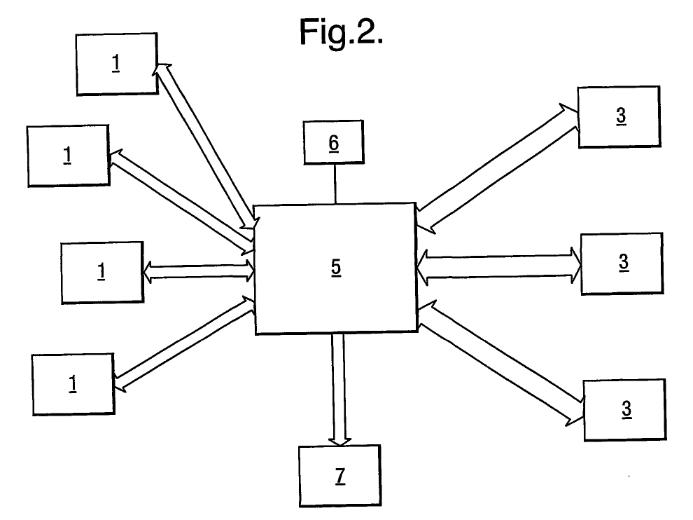

FIG. 2 is a schematic overview of one embodiment of the invention;

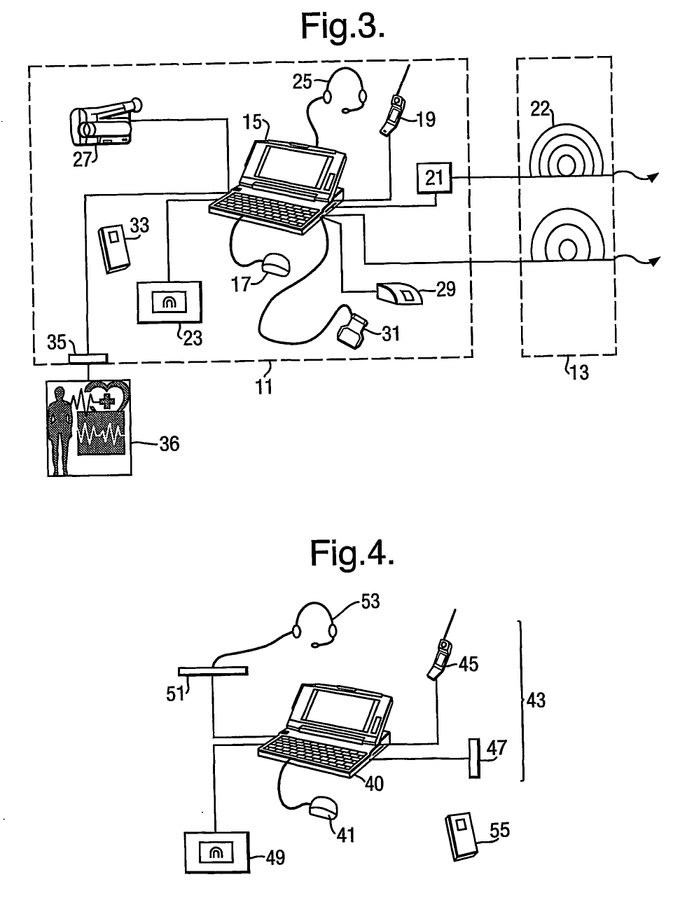

FIG. 3 schematically illustrates one of the mobile user stations in the system of FIG. 2;

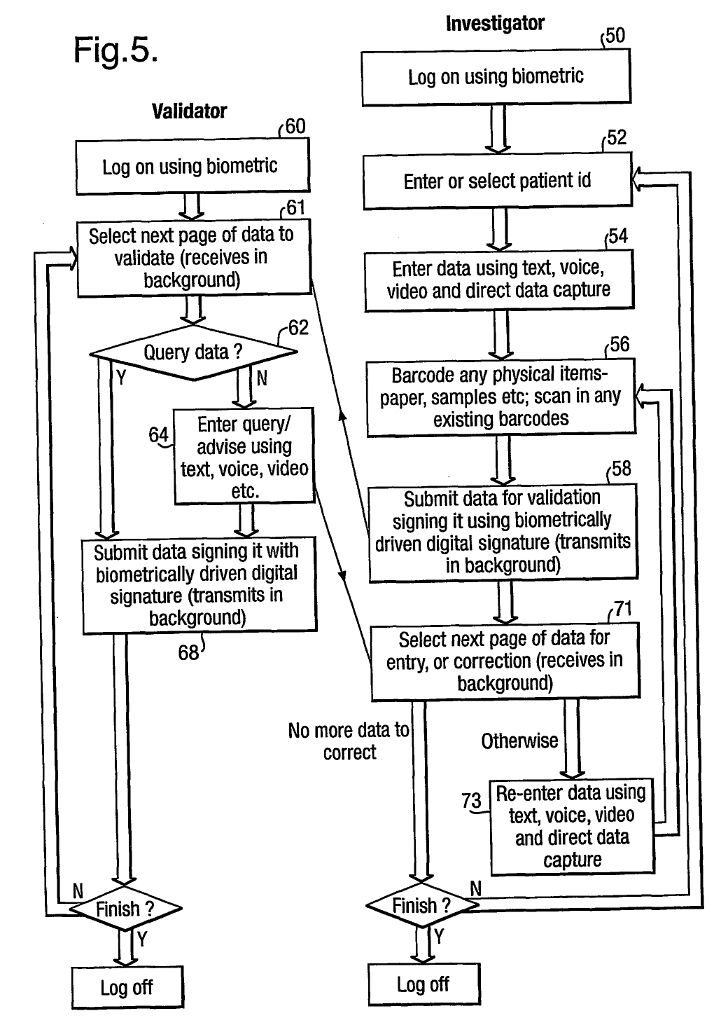

FIG. 4 schematically illustrates a validator station from the system of FIG. 2;

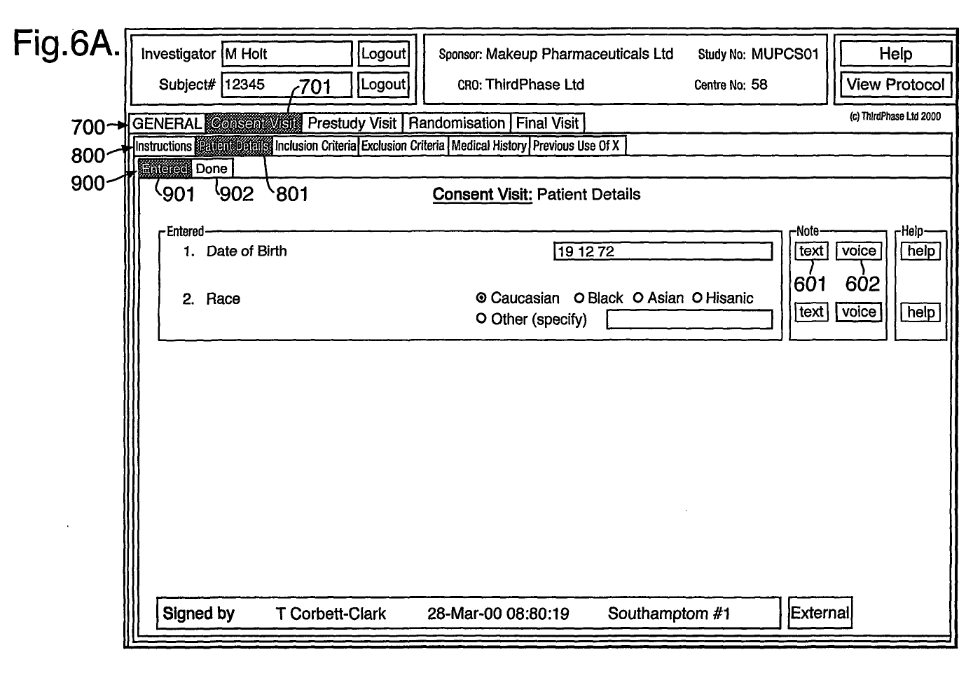

FIG. 5 is a flow-diagram illustrating the submission and validation processes; and

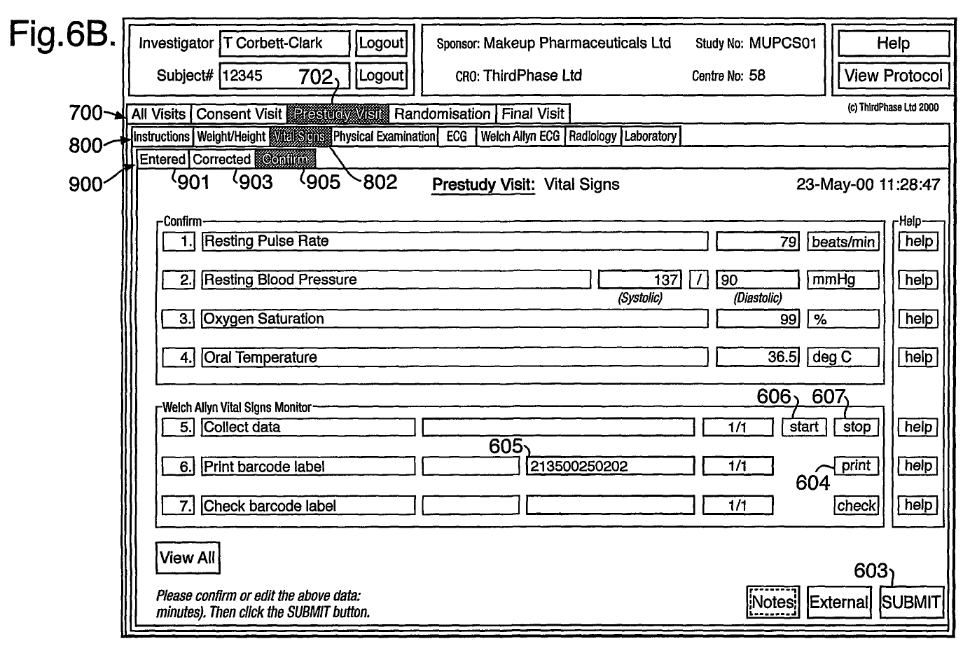

FIGS. 6A and B show examples of single pages of an electronic case record form used in an embodiment of the invention.

An embodiment of the invention applied to the acquisition of clinical trials data will be described below. It should be appreciated, though, that the invention and the principles of the system are applicable to other fields in which the security and validity of the data being collected from a plurality of distributed sites is important.

FIG. 2 schematically illustrates an overview of the system. The data is collected from a plurality of distributed sites by mobile user stations 1. These mobile user stations are in communication via a central server 5 with a number of validator stations 3 whose function is to check, in real-time, the data prepared by the user station 1 and to provide either validation of the data or advice on the improvement of the data. In the clinical trials environment the real-time nature of this validation means that adjustments or re-measurements can take place during the same patient visit, i.e. before the patient leaves the surgery.

The validator stations need not be in a single location and are preferably mobile. In fact, for a worldwide system providing 24 hour validation it would be desirable that the validator stations are located in different time-zones. They provide a “virtual central laboratory” which provides constant feedback to the users and thus improves the quality of the data collection process.

The data collected and validated is stored in a secure database 6 at the server 5 and the data being collected may be monitored by the sponsors of the process using read-only monitoring stations 7.

FIG. 3 schematically illustrates one of the mobile user stations 1. In this embodiment it consists of two main elements, a main case 11 which is the size of a small suitcase and carries most of the hardware necessary for the operation of the system, and a support bag 13 which carries the power supplies and extensible power leads and extensible telephone leads for the hardware in the main case 11. The system can be run from mains power, its own rechargeable batteries, or a car battery or other power source. The main item in the main case 11 is a portable computer 15 which is provided with a mouse 17 and links to the other hardware in the case. This includes communication means which can consist of a mobile phone 19 and/or modem 21 for connection to a conventional telephone land line via the extensible lead 22 in support bag 13. Biometric security is provided by the fingerprint or iris scanner 23.

Facilities for the recording and playback of audio data are provided by audio headset 25 and for the recording of video data by video camera or digital camera 27. Further, to provide close integration of physical items such as other paper forms print-outs or samples, a bar code printer 29 and scanner 31 are provided. Conveniently the case 11 includes other items required by the investigators such as sticky labels for the bar code printer, and possibly ready-printed bar codes.

To provide for communication with the user independently of the main system a radio pager 33 is included. This can be used to provide a prompt in the event of a station becoming inactive, to provide a “wake-up” call to occasional users to provide notification of emergency events.

The computer 15 is also provided with an interface 35 for the direct connection to medical devices 36 such as vital signs monitor, static blood pressure, ambulatory blood pressure, holter monitor, 12 lead resting ECG, 12 lead stress ECG, echocardiogram, abdominal echo, sigmoidoscope, brochascope, gastroscope, opthalmoscope, otoscope, arthroscope, EEG, CTscan, Tomograms, Xray, NMR, myogram, urogram, pulse oximetry, pulse meters, respiratory rate, resistance phlesmography, spirometry. This provides for direct electronic capture of the signals from such devices. Conveniently the computer 15 may be programmed to display a representation of the normal controls of the device on the display panel of the computer. Manipulation of the displayed controls, for instance using the mouse 17, can then allow the user to operate the medical device directly from the computer. Further, such operation is possible without the user needing to be re-trained, they just use their normal experience of the medical device.

FIG. 4 illustrates one of the validator stations 3. It consists of a mobile computer 40 with a communications link 43 comprising a mobile telephone 45 and modem for telephone land line connection 47. As usual the computer is operated by a pointer device such as a mouse 41. For verification of the identify of the validator a biometric sensor 49 is provided which can be a fingerprint or iris scanner. Audio playback and recording are provided for by means of interface 51 and audio input/output device such as a headset 53 or by means of an external microphone and the computer's internal speaker. Finally, a radio pager 55 is provided, this allowing for the validator to be alerted to the immediate, real-time, need for validation of a data set submitted by a user.

The use of the system will be described with reference to FIG. 5 and to a typical patient visit during clinical trials.

First the investigator (referred to above as the user) verifies the subject's identity and logs onto the system. As illustrated by step 50 this requires the investigator to establish his or her identity using the biometric identity verification device 23 such as a fingerprint scan or iris scan. The identity of the patient can also be biometrically verified.

The investigator can then view and complete an electronic CRF by filing the responses required by an on-screen “form” consisting of multiple pages as illustrated by steps 52 and 54. FIGS. 6A and 6B show screen printouts of two different pages of the form and it can be seen from FIG. 6A that in addition to entering the text data required by the form, there is provision for adding notes in the form of text or voice by operating the displayed “buttons” 601, 602. The system includes local logic and editing checks for the entry of the data into the form and it is important to note that the form is provided from the local computer 15, not, as with a conventional browser served from a central site using a communications link. Thus the acquisition of the data is independent from the rest of the system. The form also includes the provision of on-line help, such as approved abbreviation checkers, medical dictionaries and a drug lookup dictionary. Again these assist the user in ensuring that the data entered is correct and useable.

It will be seen from FIGS. 6A and 6B that the pages of the form are accessed as individual tabs, each of which is a complete screen, requiring no scrolling. This makes data entry easy and avoids the risk of parts of the form not being seen. The system provides a set of tabs 700 of which the first “general” gives general information and the remaining “consent visit” 701, “pre-study visit”, “randomization”, and “final visit” correspond to the different visits a patient will make to the clinic. In FIG. 6a the tab “consent visit” 701 is selected. Within each of the tabs 700 there is an appropriate set of subsidiary tabs 800, each corresponding to a different set of data to be completed. In FIG. 6A the patient details” tab 801 is selected to allow the entry of the patient details. At each visit of the patient, each of the tabs 800 will be selected, to form the complete record of that visit. It is possible that the different tabs 800 may be completed by different practitioners, for instance a tab requiring the entry of data relating to a scan might be entered in the radiology department, whereas other data might be entered in different departments. The element 900 of the screen gives an indication of the history of that form and, in some tabs allows access to earlier versions of the form, for instance as originally entered, and as subsequently corrected after comments from the validator. Such different versions are accessible using buttons 901, 902.

The completion of-the electronic CRF may include the taking of physiological data, which can involve the direct capture of data directly from medical devices under control from the CRF as illustrated in FIG. 6B by using buttons 606 and 607. In addition to the importation of this data directly, it may be that print-outs from other non-interfaced medical devices are generated, or that other paper records or samples from the patient are acquired. In order that these can be successfully integrated-into the data acquisition process, at step 56 the investigator uses the bar code printer to print a unique bar code label which is fixed to the item. The printer is controlled from the CRF by button 604 illustrated in FIG. 6B. The system automatically associates this unique reference between the item and the electronic CRF by storing it in the form as illustrated at field 605.

Since both the investigator and validator have mobile telephones in their stations, it is possible to provide for direct communication between them, thus providing immediate help for the investigator, and for the system to log the existence of the call.

In step 58 the investigator then certifies that the form is complete by “signing it” with a biometric such as a fingerprint or iris scan. The information is then encrypted, after which it cannot be changed. The complete electronic CRF page is transmitted to the central server 5 which stores it (to from part of the audit trail) and sends it to the desired validator station 3. If for some reason the transmission fails or is not possible, the data is saved until the transmission can be completed later.

It will be noted that the transmission of the data occurs in the background, i.e. invisibly to the user. This allows the user (the investigator) to continue with the examination by filling in a different part of the electronic CRF, or by examining another patient. In due course the page will be received back from the validator, again in the background as illustrated at step 71, so that at a convenient point the investigator can select that page and take whatever action is appropriate for its correction (for instance re-examining the patient). The operation of the communications at the validator station is similarly invisible to the validator. Thus the pages of data are received for validation in the background as illustrated at step 61, possibly while the validator is examining different pages, possibly from different sites. The transmission from the validator, after validation, also occurs in the background as illustrated at step 68. Thus neither the investigator nor the validator is restricted to awaiting for communications from the other side before continuing on other work.

If for any reason the communications are taking a long time, the investigator or validator is permitted to log off. Then, should data be received for action the radio pagers 33 and 55 can be used to alert the investigator or validator to the need to log back onto the system and continue.

The validation process is illustrated at step 60 through 70 of FIG. 5. The validator is the person or persons responsible for ensuring that the information transmitted from the investigator is complete, correct and of sufficient quality to be useable. This is important because often, especially in the case of specialized data, such as ECG, the investigator will not have the skills or training necessary to make this determination. Firstly, the validator logs on at step 60 using biometric security via fingerprint or iris scan 49 in a corresponding way to the investigator. It should be noted that the identity of investigators and validators logging on is logged by the system to maintain a complete audit trail of those using the system.

The electronic CRF is received via the communications link 43 at step 61 and the validator sees the electronic CRF exactly as the investigator saw it. The validator interrogates the data and decides if it is acceptable. The validator cannot make any changes to the original data, but can return to the investigator a new version as shown at step 64 if the data is unacceptable. The validator can indicate the reason for rejection of the original by attaching a text or voice annotation in the new version. The new version in then stored into the database at step 68.

Because the investigator receives a new, annotated electronic CRF he or she then has an opportunity immediately to take remedial action while the subject is still present. The investigator can thus make whatever corrections are necessary, as illustrated at steps 71 and 73 of the process and resubmit the data for validation. FIG. 6B illustrates another page of the data, this time after one round of validation. As illustrated by tab 702 this page is from the pre-study visit section, and the tab 802 is selected from entry of vital signs such as resting pulse rate, resting blood pressure, oxygen saturation, oral temperature etc. This data was first entered by the investigator and the data as initially entered can be viewed by selecting tab 901. The validator checked the data after submission by the investigator and may have made suggestions for changes or corrections and these would have been previously viewed by the investigator, and can now be viewed by selecting tab 903. The current version of the data following correction by the investigator is selected by tab 905 and is the data illustrated in FIG. 6B. Thus successive versions of the data are viewable using the tabs 900. Once the data is correct it is submitted again by the investigator using button 603, whereupon it will be rechecked by the validator and if correct signed off by the validator. All versions of the form, from entry, suggested correction, corrected version and final validated version are stored in the database to form the audit trail.

It will be appreciated that the use of tabs 700 means that previous data can be studied easily by the investigator or validator, or any other authorized user of the system. Each form needs to be submitted using a digital signature thus ensuring authenticity of the data, and each form is logged in the database, as well as being sent for appropriate, validation or correction. The use of the tabs 800 means that the different parts of the electronic CRF do not need to be filled in any particular order. Thus patients can visit the clinicians appropriate for the different pages in any convenient order, and at different times.

The validator can accept the re-submission, if it is acceptable, by signing it off with a fingerprint scan forming a digital signature at step 68 in which case the CRF is stored into the database 6, along with a time stamp storing the date and times of the activity being recorded. Such times are local to the activity being documented and including the year, month, day, hour and minute. Finally the investigator and validator log off.

The server 5 is a high-availability system with redundant discs and power supplies, housed in a secure environment. The data is encrypted, not only with the keys derived from the investigator and validator, ensuring that it cannot be falsified and that its origin and the origin of validation is recorded, but also with a key unique to the sponsor of the data collection process. Periodically the data in the database is delivered to the sponsor organization by such delivery methods as tape or CD or electronic link.

The portable computer 15 in the user station 11 is programed only to run the data collection software. This eliminates the possibility of the data or audit trail being contaminated by other software.

It should also be noted that although the validation process above has been described with one validator checking the CRF, in fact the server 5 is adapted to send the CRF in turn to other validators if special input is needed. For instance, data of one type may need to be checked by one specialist and data of another type by another. However, only one person processes the form at any time, thus ensuring a linear audit trail.

The communication between the investigators, validators and server can be via the Internet, using either dial-up connections or wired or wireless LAN connections.

One advantage of the provision of video capture at the user station using video camera 27 is that it is possible to have the investigation recorded on video. Further, problems such as the need for guidance in the correct use of medical devices, such as the placement of electrodes for an EEG examination can be solved by real-time reference to the validator. It may be, for example, that the validator notices a deficiency in the data provided by the investigator, and that this deficiency can then be seen through the video recording to be a result of incorrect usage of equipment In a traditional system the data from such a patient visit would be excluded from the trial. With the present system it is possible to correct the data.

The manner in which the data is digitally signed will now be described. Because the system is designed to cope with data from many different sites (which may use different character sets in the encoding of data) it is important that the digital signing process is robust to different character encodings. A character encoding is a table giving the relationship between characters and binary digits of data (bits). It is of course possible to change the character encoding (thus changing the bits) without altering the characters (e.g. the text). This is often found in different ways of encoding text between different regions (for example Europe, USA, Asia). However, it presents problems in the use of digital signatures.

Digital signature algorithms operate by having two keys. One key is kept private and is used to sign a document and the other key is made public and is used to verify the signature (although in certain circumstances the use of the public and private keys can be reversed). Signing involves the application of an algorithm to a private key (which is effectively a binary number) and a document (in its binary form) to produce another binary number which is a digital signature. Verification involves the application of an appropriate algorithm to a public key, the document and the signature, which produces a Boolean result which is true if the signature is valid and false if the signature is invalid.

If any of the document, signature or public key change then the result of verifying the signature is false. Therefore, the document plus signature plus public key cannot be altered without detection. Thus a digital signature provides both document authenticity and document integrity.

With the present invention structured data which is being acquired is described using XML (Extended Mark-Up Language). An example of an XML document is given below.

<?xml version= ‘1.0’?>
<form subject=‘Fred Bloggs’date=‘5 April 2000’>

<question1 answer=‘yes’>
</question1>

</form>

Because XML is written using text characters, the same XML document can be encoded in different ways in different systems (depending on the text character encoding used by that system). Although a change in character encoding does not change the meaning of the data, it does change the underlying bits and because a digital signature and verification involves applying algorithms to the underlying bits, a change in the character encoding will result in the digital signature not functioning correctly. For example an XML document may be parsed into a database for storage and/or analysis and later regenerated into XML. Although the meaning of the document is invariant to such transformations, the validity of the signature will not be.

Furthermore, it will be appreciated from the description of the specific system for acquiring clinical trails data that there is a need there, and in many other fields, to acquire not only text data but also arbitrary binary data (such as data from the medical devices etc). In order to provide for security of such data, ideally that data needs to be signed also.

With an embodiment of the present invention arbitrary binary data is first converted into text characters using Radix64. This is a method of representing arbitrary binary data using characters in which one of 64 characters is used to represent each possible combination of six bits. Thus Radix64 is useful because it enables arbitrary binary data to be included as text characters, and thus included in an ordinary XML document. Thus with this embodiment of the invention an electronic document, such as the electronic CRF above, is converted into XML, preserving the structure, and using Radix64 to encode any arbitrary binary data. Then both the character encoding and distribution of white space in the document are normalized, for instance by encoding the characters according to an international standard such as Unicode and by eliminating all contentless white space. The digital signature algorithm is then applied to the result to produce a digital signature. This digital signature is also encoded as Radix64 along with the public key and these characters are added to the original XML document to form a complete signed XML document.

Such a digitally signed XML document is shown below.

<?xml version= ‘1.0’?>

<signed>

<publicKey nbytes=‘160’ nchars=‘216’>

MIGdMA0GCSqGSIb3DQEBAQUAA4GLADCBhwKBgQCtjI0487wO8Km8oV

fNsYnoaQQQNZQ8OHBZS6orOUGDsdikgB859ybKwikfyytU155ko9k9j8tTOP
1MYpFbOEDoxPs22KV1KxGH4MtnqdqIy6hePaspmYpPBiTp147WELhzBMYe/F
30hgKROfhFhsFA6NbmVWMhnpdq81CMEREiaNPCj7PIBEQAA

</publicKey>
<data>

<form subject=‘Fred Bloggs’ date=‘6 April 2000’>

<question1 answer= ‘no’>
</question>
<textnote nbytes=‘6’ nchars=‘8’>

bm90ZSAx
</textnote>

</form>

</data>
<signature nbytes=‘128’ nchars=‘172’>

eBgik7klXimw7zisuNobwx/baNFA+yz5F1fxye0mnttW56WMPy2fBC

zQZf5nF4wbVDcCfkNzUGgvdDUNoMNHKGoA+DKPae6pWnEioJV8pWAaI3bS6
G0MkLs9gBRxlzuSuw6sNsrGNxQaLh6UbXXjO5AMRMYCHkJAXwwa

</signature>

</signed>

The public key and signature tags are clearly seen, each containing Radix64 encoding of the public key and digital signature respectively. The signed part of the document is enclosed in the data tags.

To verify the signature the complete XML document is parsed to extract the public key and the signature. The remaining XML must then be normalized (by converting the characters using Unicode and eliminating white space). This will create the same bit pattern as used in the original digital signature algorithm. The digital verification algorithm can then be used on this bit pattern to verify the signature. Between signing and verifying the data may be changed into a new representation which preserves the meaning (in other words which can be reversed into the original XML). The validity of the signatures survives the transformations because of the use of the normalized representation both on signing the document and on verification.

The invention also improves the security and usability of the system by driving the digital signatures using biometrics. This means that the result of biometrically authenticating/identifying a person is used to look-up their private key from a table of biometric/private key pairs. This is the only way of obtaining the private key and because the biometric is physically unique, only the true person can sign the document (providing authenticity), and that person cannot deny that they signed the document (providing non-repudiation).

It will be appreciated, therefore that the use of XML to encode the data and Radix64 to encode the arbitrary data, together with biometrically driven digital signatures provides for a high level of usability and security in the system. This is not only applicable to the acquisition of data in clinical trials, but to any system in which a high level of security and usability is required.

1. A system for the acquisition and verification of data from plural remote sites, the system comprising a plurality of user stations, a plurality of validator stations and a database for storing the data,
each of the user stations comprising a computer adapted to accept input of data to form a data set; a biometric identity verification device for verifying the, identity of the user; means for digitally signing the data set and appending it to the data set to produce a signed data set; and communication means for transmitting the signed data set to one of the validator stations in response to biometric verification of the identity of the user and for receiving validation information from the validator stations;
each of the validator stations comprising a computer; a biometric identity verification device for verifying the identity of the validator; communication means for receiving the signed data set from the user stations and transmitting validation information to the user stations; means for appending a digital signature of the validator to the signed data set to produce a validated data set;
the database storing the signed data set and the validated data set.

2. The system according to claim 1 wherein each of the validation stations is mobile, the computer comprising a portable computer.

3. A system according to claim 1 or 2 wherein each of the user stations is mobile, the computer comprising a portable computer.

4. A system according to claim 2 or 3 wherein at least one of the validator stations and user stations comprises a portable case housing the portable computer, biometric identity verification device and means for appending a digital signature.

5. A system according to any one of the preceding claims wherein the data is in the form of user-generated notes and electronically-captured data.

6. A system according to'any one of the preceding claims wherein the user-generated notes comprise text or audio data.

7. A system according to any one of the preceding claims wherein the electronically-captured data comprises measurement data from a sensing device.

8. A system according to claim 7 wherein each user station comprises an interface for interfacing to said sensing device.

9. A system according to claim 8 wherein the portable computer is adapted to display a user-manipulable representation of controls of the sensing device, the sensing device being operated in response to user manipulation of the representation.

10. A system according to claim 7, 8 or 9 wherein the sensing device is a medical device.

11. A system according to claim 10 wherein medical device is at least one of a vital signs monitor, static blood pressure, ambulatory blood pressure, holter monitor, 12 lead resting ECG, 12 lead stress ECG, echocardiogram, abdominal echo, sigmoidoscope, arthroscope, EEG, CTscan, Tomograms, Xray, NMR, myogram, urogram, pulse oximetry, pulse meters, respiratory rate, resistance phlesmography, spirometry.

12. A system according to any one of the preceding claims wherein a use right of the user station and validator station is granted upon verification of identity by the respective biometric identity verification device.

13. A system according to claim 12 wherein said use right expires after a predetermined period of non-use of the station.

14. A system according to any one of the preceding claims wherein the digital signature is obtained by reference to the output of the biometric identity verification device.

15. A system according to any one of the preceding claims wherein the database stores the signed data set and the validated data set with a time stamp indicating its date and time of origin.

16. A system according to any one of the preceding claims further comprising a bar code printer for producing bar codes for application to physical items associated with the data set, the bar code being recorded in the data set.

17. A system according to any one of the preceding claims further comprising a bar code scanner for scanning bar codes on physical items associated with the data set, the bar code being recorded in the data set.

18. A system according to any one of the preceding claims wherein the communication means in the user station is adapted to communicate with the validator station by automatically opening a communication link therewith, and in the event of loss of said link automatically to reestablish said link, both without the intervention of the user.

19. A system according to claim 18 wherein the communication link comprises at least one of a cellular radio telephone and modem connection to a telephone land line and LAN and wireless LAN.

20. A system according to any one of the preceding claims further comprising monitoring stations adapted for read-only access to the database.

21. A system according to any one of the preceding claims wherein said data is drug trials data.

22. A system according to claim 21 wherein said drug trials data comprises at least two of: subject records, text or audio notes on the response of the subjects to the drug, user obtained measurement data relating to the physical condition of the subject, electronically captured data from medical devices and video data recording examination of the subject.

23. A system according to any one of the preceding claims wherein said data set is converted into a normalised representation, and said means for digitally signing the data set is adapted to apply a digital signing algorithm to a first key and to the normalised representation to produce the digital signature.

24. A system according to claim 23 wherein said data set is encoded in XML (Extended Mark-up Language) before conversion to said normalised representation.

25. A system according to claim 23 or 24 wherein said normalised representation is Unicode.

26. A system according to claim 23, 24 or 25 wherein said normalised representation includes normalization of white space by eliminating all contentless white space.

27. A system according to claims 23, 24, 25 or 26 wherein the first key is a private key personal to the user.

28. A system according to any one of claims 23 to 27 further comprising a data authenticator for authentifying the signed data set by converting the input data to the normalised representation, and applying a checking algorithm to the normalised representation of the input data, the digital signature and a second key.

29. A system according to claim 28 wherein the second key is a public key.

30. A system according to claim 29 wherein the means for digitally signing the data set is adapted to include the public key in the signed data set.

31. A system constructed and arranged to operate substantially as hereinbefore described with reference to and as illustrated in the accompanying drawings.

32. A method of digitally signing a data set comprising the steps of converting said data set into a normalised representation, and applying a digital signing algorithm to a first key and to the normalised representation of the data set to produce the digital signature.

33. A method according to claim 32 wherein the data set comprises text characters and the normalised representation is an international standard character set encoding the text characters as binary data.

34. A method according to claim 32 or 33 wherein the data set is written in XML (Extended Mark-up Language).

35. A method according to claim 32, 33 or 34 wherein the normalised representation is Unicode.

36. A method according to claim 32, 33, 34 or 35 wherein said normalised representation includes normalization of white space by eliminating all contentless white space.

37. A method according to any one of claims 32 to 36 wherein the data set comprises arbitrary binary data encoded as Radix64 characters in an XML document.

38. A method according to any one of claims 32 to 37 wherein the first key is a private key.

39. A method according to any one of claims 32 to 38 wherein the digital signature is encoded as Radix64 characters.

40. A method according to claim 38 or 39 wherein a second key and said digital signature are appended to said data set.

41. A method according to claim 40 wherein said second key is encoded as Radix64 characters.

42. A method according to any one of claims 32 to 41 wherein said first key and said digital signature are appended to said data set to form an XML document.

43. A method of authentifying a data set signed by the method of any one of claims 32 to 41 comprising the steps of converting the data set to the normalised representation, and applying a checking algorithm to the normalised representation of the data set, the digital signature and a second key.

44. A method according to claim 40, 41, 42 or 43 wherein the second key is a public key.

45. A method of digitally signing a data set according to claim 32 and substantially as hereinbefore described with reference to and as illustrated in the accompanying drawings.

46. A method of digitally signing a data set comprising the steps of obtaining a biometric signal from a user, obtaining a private key with reference to the biometric signal and applying a digital signing algorithm to the private key and to the data set to produce the digital signature.

47. A method according to claim 46 wherein the private key is obtained by accessing on the basis of the biometric signal a look-up table of private keys.

48. A method according to claim 46 or 47 wherein the biometric signal is obtained from an iris scan or fingerprint scan.
